(19) United States
(12) Patent Application Publication
(10) Pub. No.: US 2008/0104505 A1
(43) Pub. Date: May 1, 2008

(54) Method, System and Program Product Supporting Customized Presentation of Toolbars Within a Document

(76) Inventors: Susann M. Keohane, Austin, TX (US); Gerald F. McBrearty, Austin, TX (US); Shawn P. Mullen, Buda, TX (US); Jessica K. Murillo, Round Rock, TX (US); Johnny Meng-Han Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/553,712

(22) Filed: Oct. 27, 2006

(51) Int. Cl. G06F 17/00; G06F 3/048

(52) U.S. Cl. 715/246; 715/781; 715/272

(57) ABSTRACT

In response to a user marking a plurality of regions within a document of the application program, the application establishes a corresponding plurality of sections of the document including at least a first section and second section. In response to user selection of one or more toolbars from among a plurality of toolbars available within the application program, the application associates a first customized toolbar view with the first section and a second customized toolbar view with the second section, where the first and second customized toolbar views include different sets of the plurality of toolbars. In response to user navigation of the document to cause the sequential display of multiple ones of the plurality of sections of the document, the application automatically presents the first customized toolbar view when the first section of the document is displayed and automatically presenting the second customized toolbar view when the second section of the document is displayed. In addition, the application persistently saves the first and second customized toolbar views in association with the document, such that the first and second customized toolbar views are presented automatically by the application program in association with the first and second sections, respectively, when a user subsequently views the document.

### BACKGROUND OF THE INVENTION

1. Technical Field

The present invention relates in general to computers and other data processing systems and in particular to graphical user interfaces (GUIs). Still more particularly, the present invention relates to an improved method, system and program product for customizing the presentation of toolbars within an application program.

2. Description of the Related Art

An application program is a software program that utilizes computer resources to perform one or more specific tasks for a user. Application programs often employ a graphical user interface (GUI), which presents graphical components and associated textual identifiers to a user via a display device and enables a user to interact with a computer through the manipulation of the graphical components utilizing a pointing device (e.g., mouse, glide pad or touch screen stylus). Conventional application programs include one or more toolbars. A toolbar is a GUI component containing a group of related buttons or icons generally displayed in a linear fashion. When a user selects a toolbar icon or button using a pointing device, a particular function or feature of the application program is activated.

The functions or operations associated with toolbar icons are often associated with closely related tasks, such as formatting text, creating and formatting drawing, and creating and formatting tables. Because the display area within a GUI is limited, users generally choose to display fewer than all available toolbars of an application program at any given time. Generally, user preferences regarding the presentation of toolbars are uniform either for all documents of the user (e.g., based upon a preference recorded in the user's profile) or for all pages of a particular document created utilizing a particular application program. Currently, if a user wishes to perform different tasks on different pages within a document, the user must manually invoke and terminate the presentation of toolbars for each task or choose to sacrifice otherwise useful display area by leaving unused toolbars open constantly. Consequently, an improved method for customizing the presentation of toolbars within a document of an application program is needed.

### SUMMARY OF THE INVENTION

A method, system, and computer program product for customizing the presentation of toolbars by an application program are disclosed.

According to one embodiment, in response to a user marking a plurality of regions within a document of the application program, the application establishes a corresponding plurality of sections of the document including at least a first section and second section. In response to user selection of one or more toolbars from among a plurality of toolbars available within the application program, the application associates a first customized toolbar view with the first section and a second customized toolbar view with the second section, where the first and second customized toolbar views include different sets of the plurality of toolbars. In response to user navigation of the document to cause the sequential display of multiple ones of the plurality of sections of the document, the application automatically presents the first customized toolbar view when the first section of the document is displayed and automatically presenting the second customized toolbar view when the second section of the document is displayed. In addition, the application persistently saves the first and second customized toolbar views in association with the document, such that the first and second customized toolbar views are presented automatically by the application program in association with the first and second sections, respectively, when a user subsequently views the document.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary data processing system, as utilized in an embodiment of the present invention;

FIG. 2A illustrates a first view of an exemplary document created utilizing an application program in accordance with the present invention;

FIG. 2B illustrates a second view of the exemplary document of FIG. 2A; and

FIG. 3 is a high level logical flowchart of an exemplary method of customizing the presentation of toolbars by an application program in accordance with one embodiment of the present invention.

### DETAILED DESCRIPTION OF AN ILLUSTRATIVE EMBODIMENT

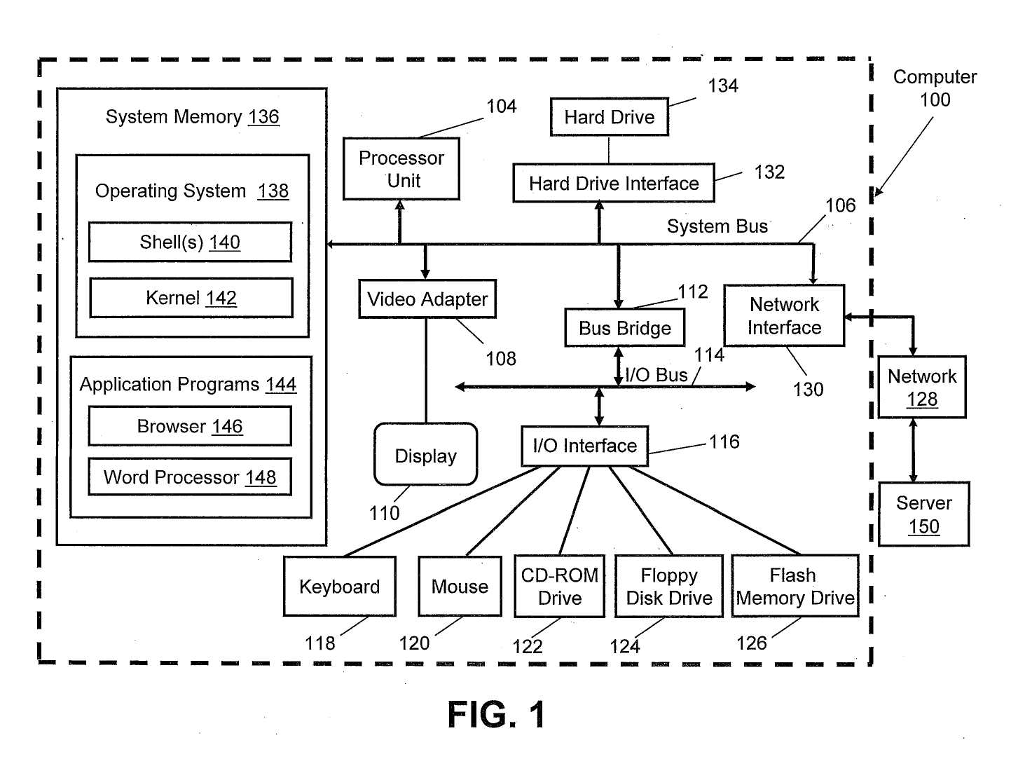

With reference now to the figures and in particular with reference to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In a preferred embodiment, hard drive 134 populates the system memory 136, which is also coupled to system bus 106. System memory is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and mouse and keyboard management.

Application programs 144 include a browser 146 and word processor 148. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), etc. These and other variations are intended to be within the spirit and scope of the present invention.

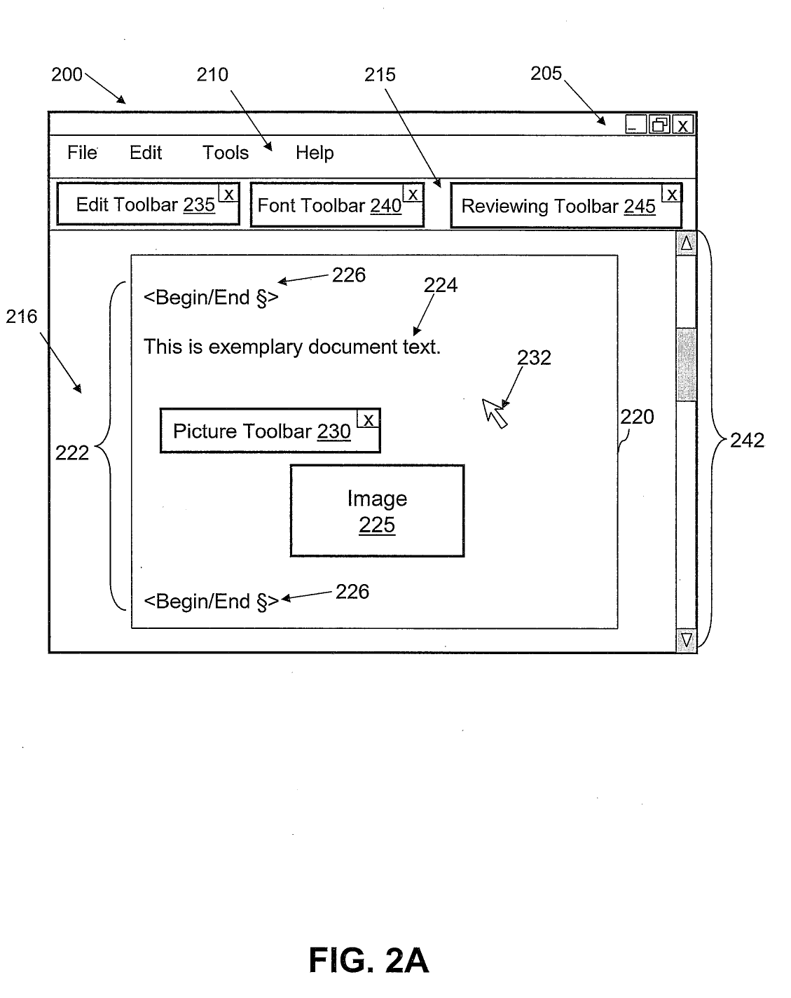

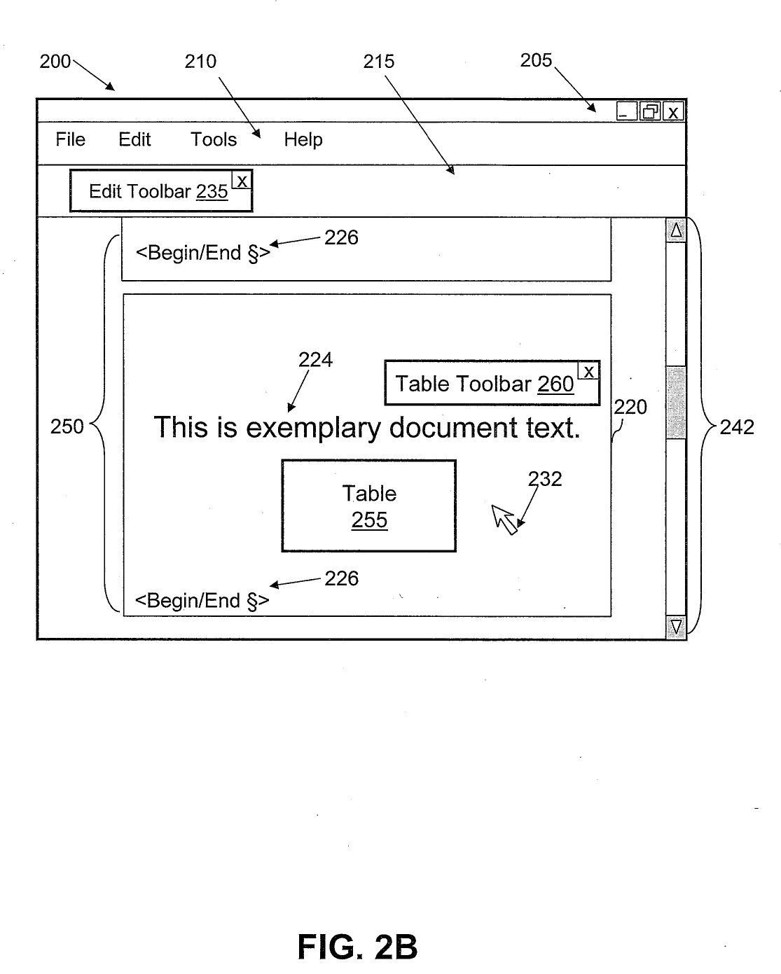

With reference now to FIG. 2A, there is depicted an exemplary graphical user interface (GUI) 200 of an application program, such as word processor 148, browser 146, a presentation application, or other application program, in accordance with the present invention. GUI 200 includes window frame 205, menu bar 210, a toolbar area 215, scrollbar 242 and a document display area 216. Within document display area 216, a document 220 is presented for user editing utilizing keyboard 118 and/or mouse 120, which controls a graphical pointer 232 displayed within GUI 200. As utilized herein, the term “document” refers to a data file used by a user of application program, including, but not limited to, a file within word processor 148, a spreadsheet program, or a presentation program. The exemplary document depicted in FIG. 2A is a mixed content document including both text 224 and an image 225.

As in conventional applications, the user can edit document 220 in a variety of ways, including by keying in content and commands utilizing keyboard 118, by selecting menu entries from menu bar 210 utilizing graphical pointer 232, and by selecting icons within one or more application toolbars. In the depicted view, the toolbars presently displayed in GUI 200 include an edit toolbar 235, font toolbar 240, and design toolbar 245, all of which are presented within toolbar area 215. In addition, a picture toolbar 230 is presented “floating” within document display area 216 to enable the user to efficiently edit and format the image 225 forming a part of mixed content document 220. As will be appreciated, the toolbars presented within GUI 200 can be selected by a user, for example, by selecting the toolbars to be presented from a dropdown menu accessible under the Edit menu displayed within menu bar 210.

In accordance with the present invention, the presentation of toolbars can be customized within a document, such as document 200, in response to user designation of particular document sections for which a given set of toolbars is to be displayed. In one embodiment, the user designates the boundaries of a section 222 of document 200 for which a particular set of toolbars is to be presented with a pair of section tags 226. Section tags 226, which can be inserted or deleted, for example, by selecting an entry in the Edit menu, are preferably only selectively visible and not presented within printed versions of document 200. For example, in one embodiment, section tags 226 are only visible if the user of GUI 200 has a specific document setting, such as View Codes, is selected from menu presented within menu bar 210.

In an alternate embodiment of the present invention, a document section can be designated utilizing a single section tag 226 at the end of the section. In this alternative embodiment, the customized toolbar view for that section would be presented for any portion of the document preceding the section tag until another section tag or the beginning of the document is reached. Similarly, in yet another alternative embodiment, a user designates a section of a document by placing a single section tag at the beginning of a document section. In this alternative embodiment, the customized toolbar view for that section would be presented for any portion of the document following the section tag until another section tag or the end of the document is reached.

Regardless of which technique is utilized to demark section 222, the customized toolbar view defined by the user to include edit toolbar 235, font toolbar 240, design toolbar 245, and picture toolbar 230 is presented automatically each time the user views section 222 of document 220 within document display area 216.

With reference now to FIG. 2B, there is depicted another view of document 220 of FIG. 2A, which includes a second user-defined document section 250 containing text 224 and a table 255. Based upon the difference in content between section 220 and section 250, the user has selected the presentation of edit toolbar 235 and table toolbar 260 when viewing section 250, but not font toolbar 240, reviewing toolbar 245 and picture toolbar 230. The user may thus navigate back and forth between first document section 222 (of FIG. 2A) and second document section 250 (of FIG. 2B), for example, utilizing keyboard commands or scrollbar 240, and achieve the corresponding customized toolbar views without repeatedly manually activating/deactivating toolbars applicable to each section of the document. If multiple document sections are presented in display area 216 simultaneously, GUI 200 presents the applicable toolbars for each of the multiple document sections are displayed simultaneously (i.e., an OR operation is performed).

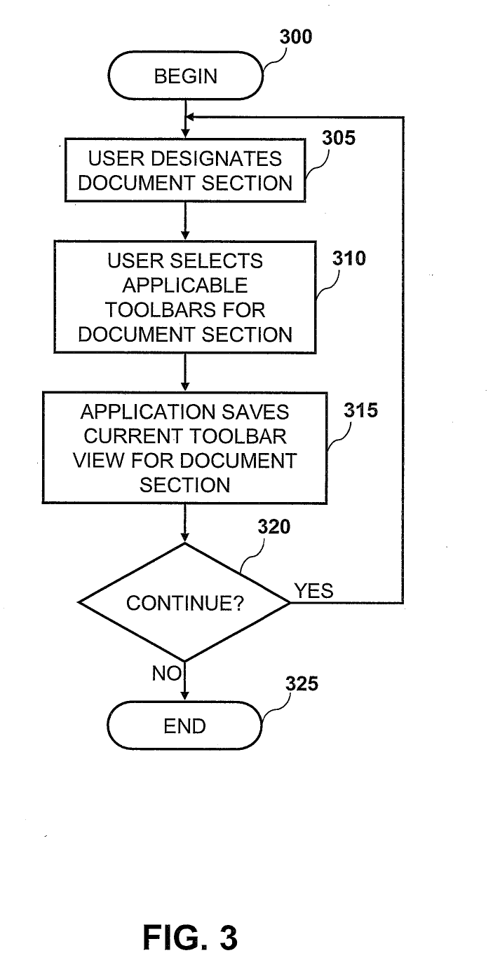

Turning now to FIG. 3, there is illustrated a high level logical flowchart of an exemplary method of customizing the presentation of toolbars within an application program in accordance with one embodiment of the invention. The process begins at block 300, for example, in response to a user of computer 100 opening a document 220 for editing within the GUI 200 of an application program, such as a presentation, spreadsheet or word processing application. As depicted in block 305, a user is then permitted to embed one or more section tags within document 200 to designate a section of a document. For example, the user may embed a section tag within a document 220 at the insertion point (e.g., a point selected by graphical pointer 232 or a cursor location) by utilizing graphical pointer 232 to select an icon on a View toolbar presented within toolbar area 215 or by selecting an option within a menu accessed via menu bar 210. Alternatively, the user may designate a section of document 220 by selecting a region of the document utilizing the well-known click-and-drag technique and then selecting a Create Section command from a pop-up menu invoked by right-clicking on the selected document region. In this case, the application presenting GUI 200 automatically determines the locations in document 220 at which to embed the section tag(s).

As shown in block 310, the user also selects applicable toolbars for the current document section, which selection can be performed either before or after the designation of the document section at block 305. The application associates the selected toolbars within the document section and automatically saves the current toolbar configuration view, for example, when the document is saved, as depicted in block 315. In one embodiment, the customized toolbar view associated with each section tag 226 of document 220 is stored persistently as a hidden attachment to document 220 (i.e., in a separate hidden file), such that the customized toolbar views are available throughout multiple viewing sessions of the document by one or more users. In an alternative embodiment, the customized toolbar view information may be embedded within the page format information of document 220 itself. In either case, during subsequent viewing and/or editing sessions of document 220, the customized toolbar view associated with each section of document 220 is automatically presented by the application as that section is displayed.

Referring now to block 320, the application determines whether the user has entered an input to designate an additional document sections. If so, the process returns to block 305 and following blocks, which have been described. If not, the depicted process terminates at block 325.

The present invention thus enables a user of an application program to select one or more toolbars suitable for a particular section of a document for presentation in association with that particular section of the document. As a user subsequently navigates through the sections of a document, the toolbars presented in association with the document thus automatically change in accordance with the user's preferences and the section(s) of the document then displayed. Further, the user's customized toolbar views are stored persistently within or with the document, enabling multiple users to share a file and efficiently utilize the customized toolbar view applicable to the data within each section of the document.

While an illustrative embodiment of the present invention has been described in the context of a fully functional computer system with installed software, those skilled in the art will appreciate that aspects of an illustrative embodiment of the present invention are capable of being distributed as a program product in a variety of forms, and that an illustrative embodiment of the present invention applies equally regardless of the particular type of computer readable media used to actually carry out the distribution. Examples of computer readable media include storage media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. i an application program that provides a graphical user interface (GUI) with toolbars, a method comprising:
in response to a user marking a plurality of regions within a document of the application program, establishing a corresponding plurality of sections of the document including at least a first section and second section;
in response to user selection of one or more toolbars from among a plurality of toolbars available within said application program, associating a first customized toolbar view with the first section and a second customized toolbar view with the second section, wherein the first and second customized toolbar views include different sets of the plurality of toolbars;
in response to user navigation of said document to cause the sequential display of multiple ones of the plurality of sections of the document, automatically presenting the first customized toolbar view when the first section of the document is displayed and automatically presenting the second customized toolbar view when the second section of the document is displayed; and
persistently saving said first and second customized toolbar views in association with the document, such that the first and second customized toolbar views are presented automatically by the application program in association with the first and second sections, respectively, when a user subsequently views the document.

2. The method of claim 1, wherein the step of establishing a corresponding plurality of sections comprises establishing a corresponding plurality of sections in response to a user inserting at least one section tag in said document for each section.

3. The method of claim 2, wherein the step of establishing a corresponding plurality of sections comprises establishing a corresponding plurality of sections in response to a user inserting a section tag in said document at a beginning and end of each section.

4. The method of claim 1, wherein the step of persistently saving further comprises persistently saving said first and said second customized toolbar views in a file attached to said document.

5. The method of claim 1, wherein the step of persistently saving further comprises persistently saving said first and said second customized toolbar views as formatting information embedded within said document.

6. A data processing system comprising:
a processor unit; and
data storage communicatively connected to said processor;
an application program within said data storage that, when executed by the processor unit, causes the data processing system to perform a method including the following steps:
in response to a user marking a plurality of regions within a document of the application program, establishing a corresponding plurality of sections of the document including at least a first section and second section;
in response to user selection of one or more toolbars from among a plurality of toolbars available within said application program, associating a first customized toolbar view with the first section and a second customized toolbar view with the second section, wherein the first and second customized toolbar views include different sets of the plurality of toolbars;
in response to user navigation of said document to cause the sequential display of multiple ones of the plurality of sections of the document, automatically presenting the first customized toolbar view when the first section of the document is displayed and automatically presenting the second customized toolbar view when the second section of the document is displayed; and
persistently saving said first and second customized toolbar views in association with the document, such that the first and second customized toolbar views are presented automatically by the application program in association with the first and second sections, respectively, when a user subsequently views the document.

7. The data processing system of claim 6, wherein the step of establishing a corresponding plurality of sections comprises establishing a corresponding plurality of sections in response to a user inserting at least one section tag in said document for each section.

8. The data processing system of claim 7, wherein the step of establishing a corresponding plurality of sections comprises establishing a corresponding plurality of sections in response to a user inserting a section tag in said document at a beginning and end of each section.

9. The data processing system of claim 6, wherein the step of persistently saving further comprises persistently saving said first and said second customized toolbar views in a file attached to said document.

10. The data processing system of claim 6, wherein the step of persistently saving further comprises persistently saving said first and said second customized toolbar views as formatting information embedded within said document.

11. A program product comprising:
a computer readable storage medium;
an application program within said computer readable storage medium that, when executed by a data processing system, causes the data processing system to perform a method including the following steps:
in response to a user marking a plurality of regions within a document of the application program, establishing a corresponding plurality of sections of the document including at least a first section and second section;
in response to user selection of one or more toolbars from among a plurality of toolbars available within said application program, associating a first customized toolbar view with the first section and a second customized toolbar view with the second section, wherein the first and second customized toolbar views include different sets of the plurality of toolbars;
in response to user navigation of said document to cause the sequential display of multiple ones of the plurality of sections of the document, automatically presenting the first customized toolbar view when the first section of the document is displayed and automatically presenting the second customized toolbar view when the second section of the document is displayed; and
persistently saving said first and second customized toolbar views in association with the document, such that the first and second customized toolbar views are presented automatically by the application program in association with the first and second sections, respectively, when a user subsequently views the document.

12. The program product of claim 11, wherein the step of establishing a corresponding plurality of sections comprises establishing a corresponding plurality of sections in response to a user inserting at least one section tag in said document for each section.

13. The program product of claim 12, wherein the step of establishing a corresponding plurality of sections comprises establishing a corresponding plurality of sections in response to a user inserting a section tag in said document at a beginning and end of each section.

14. The program product of claim 11, wherein the step of persistently saving further comprises persistently saving said first and said second customized toolbar views in a file attached to said document.

15. The data processing system of claim 11, wherein the step of persistently saving further comprises persistently saving said first and said second customized toolbar views as formatting information embedded within said document.
